(19) United States
(12) Patent Application Publication
(10) Pub. No.: US 2014/0012556 A1
(43) Pub. Date: Jan. 9, 2014

(54) APPARATUS AND METHOD FOR REAL TIME WATER QUALITY PREDICTION USING HYDRODYNAMIC MODEL

(71) Applicant: ELECTRONICS AND TELECOMMUNICATIONS RESEARCH IN, Daejeon (KR)

(72) Inventor: Chang Won LEE, Osan (KR)

(73) Assignee: Electronics and Telecommunications Research Institute, Daejeon (KR)

(21) Appl. No.: 13/794,666

(22) Filed: Mar. 11, 2013

(30) Foreign Application Priority Data
Jul. 6, 2012 (KR) 10-2012-0074053

(51) Int. Cl. G06G 7/57

(52) U.S. Cl. CPC G06G 7/57
USPC 703/9

(57) ABSTRACT

Disclosed is an apparatus and method for predicting a real-time water quality, and the apparatus including a hydrodynamic model creating unit to create a hydrodynamic model optimized to a location at which a water quality is to be predicted based on flow rate information, and a water quality predicting unit to predict the water quality by applying water quality information to the optimized hydrodynamic model.

### CROSS-REFERENCE TO RELATED APPLICATION

This application claims the priority benefit of Korean Patent Application No. 10-2012-0074053, filed on Jul. 6, 2012, in the Korean Intellectual Property Office, the disclosure of which is incorporated herein by reference.

### BACKGROUND

1. Field of the Invention

The present invention relates to an apparatus and method for predicting water quality in real time, and more particularly, to an apparatus and method for predicting water quality in real time that optimizes a hydrodynamic model in a location at which a water sensor is installed, using a flow rate of the location at which the water sensor is installed, and predicts a water quality using the optimized hydrodynamic model.

2. Description of the Related Art

With an increase in a level of environmental pollution, research is being conducted on technology for predicting a water quality in an aquatic environment such as a stream, a river, and an ocean, and monitoring a current distribution status of water quality.

A water quality model is technology for predicting a water quality of a one-dimensional, a two-dimensional, and a three-dimensional aquatic environment, set in a steady state or a dynamic state. Here, the water quality model may be divided into a hydrodynamic model that predicts a water quality through physical elements such as water level, terrain, flow rate, diffusion, precipitation, and the like, and a water quality model that predicts a water quality by a biological/chemical interactions and reactions.

Here, since the water quality model is generally used for predicting the water quality over a long term, and the hydrodynamic model is used for predicting the water quality over a short term, the hydrodynamic model is appropriate to be used for predicting the real-time water quality.

However, considering that an accuracy of the hydrodynamic model depends on an accuracy of flow rate information of a corresponding aquatic environment, in a case of a stream without a flow rate measurement site, an error occurs in the flow rate information since a flow rate of a tributary flowing into a main stream is calculated according to a ratio of an area of the tributary to an area of the main stream, due to a lack of flow rate measurement sites in Korea.

That is, since a flow rate calculated according to an area rather than an actual flow rate is used, a limit is found in that an occurrence of change in the flow rate may not be dealt with in real time to be able to be applied to the hydrodynamic model.

Also, a total phosphorus and a total nitrogen among water quality parameters are water quality parameters that are unmeasurable by a real-time sensor. Here, since a total phosphorus and a total nitrogen may not change, be generated, or be extinguished, the total phosphorus and the total nitrogen are highly important elements for functioning as a measure of eutrophication and a limit factor of an occurrence of algal bloom.

Accordingly, although technology for measuring the total phosphorus and the total nitrogen is developed, conventional technology for measuring the total phosphorus and the total nitrogen may not use a total phosphorus or total nitrogen distribution of a corresponding aquatic environment as an absolute representative value.

Accordingly, there exists a desire for a method for enhancing an accuracy of the hydrodynamic model and for using an estimation value of the total phosphorus and the total nitrogen as a distribution absolute value of the corresponding aquatic environment.

### SUMMARY

An aspect of the present invention provides an apparatus and method for predicting a real-time water quality using flow rate information and water quality information.

Another aspect of the present invention also provides an apparatus and method for using an estimation value of a total phosphorus and a total nitrogen as an absolute value representative of a total phosphorus or total nitrogen distribution.

According to an aspect of the present invention, there is provided an apparatus for predicting a real-time water quality, the apparatus including a hydrodynamic model creating unit to create a hydrodynamic model optimized to a location at which a water quality sensor is installed, based on flow rate information, and a water quality predicting unit to predict a water quality by applying water quality information of the water quality sensor to the optimized hydrodynamic model.

The water quality predicting unit may apply a total phosphorus or a total nitrogen among the water quality information to the hydrodynamic model, by setting the total phosphorus or the total nitrogen as a dissolved nonreactive material.

The water quality predicting unit may use an average value, a median value, or a real-time measurement value for each period with respect to a total phosphorus or a total nitrogen, as a representative value of a hydrodynamic model.

The water quality predicting unit may apply at least one material having a relatively low rate of reaction when compared to a physical change among water quality information, by setting the at least one material as a dissolved nonreactive material.

According to an aspect of the present invention, there is provided a method for predicting a water quality, the method including creating a hydrodynamic model optimized to a location at which a water quality is to be predicted based on flow rate information, and predicting the water quality by applying water quality information of a water quality sensor to the optimized hydrodynamic model.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a system for predicting a real-time water quality including an apparatus for predicting a real-time water quality according to an embodiment of the present invention;

FIG. 2 is a block diagram illustrating an apparatus for predicting a real-time water quality according to an embodiment of the present invention;

FIG. 3 is a block diagram illustrating a water quality sensor according to an embodiment of the present invention; and

FIG. 4 is a flowchart illustrating a method for predicting a real-time water quality according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

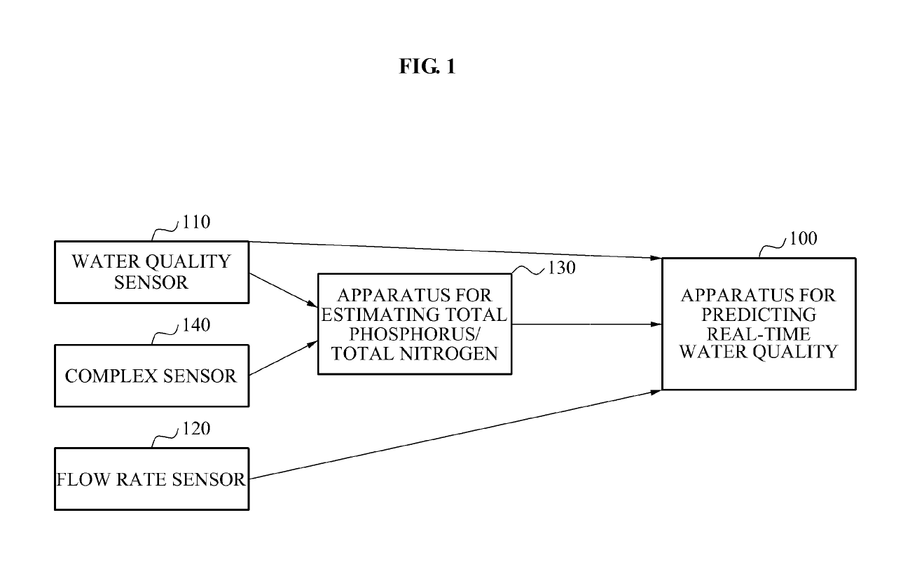

FIG. 1 is a diagram illustrating a system for predicting a real-time water quality including an apparatus for predicting a real-time water quality according to an embodiment of the present invention.

Referring to FIG. 1, the system for predicting the real-time water quality may include an apparatus for predicting a real-time water quality 100, a plurality of water quality sensors 110, a flow rate sensor 120, and an apparatus for estimating a total phosphorus/total nitrogen 130.

The apparatus for predicting the real-time water quality 100 may create a hydrodynamic model, based on flow rate information estimated by the flow rate sensor 120, and predict a real-time water quality at a location where the plurality of water quality sensors 110 is installed, by applying water quality information received from the plurality of water quality sensors 110 to the created hydrodynamic model.

Here, the hydrodynamic model may be a model to predict a water quality through physical elements such as water level, terrain, flow rate, diffusion, precipitation, and the like among water quality models.

Further, the water quality information that the apparatus for predicting the real-time water quality 100 applies to the hydrodynamic model may be a material that is able to be set to be a dissolved nonreactive material among materials estimated by the plurality of water quality sensors 110.

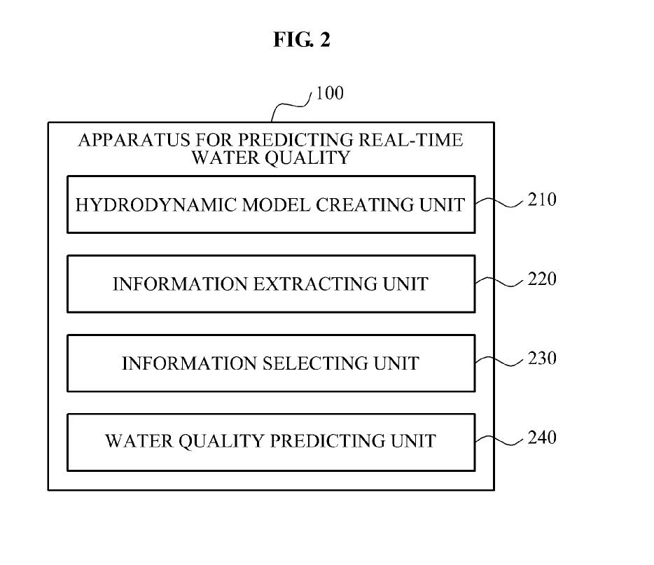

Hereinafter, a detailed configuration of predicting by the apparatus for predicting the real-time water quality 100 will be described with reference to FIG. 2.

The plurality of water quality sensors 110 may estimate a multi-parameter water quality at a location where the plurality of water quality sensors 110 is installed, and transmit the estimated multi-parameter water quality to the apparatus for estimating the total phosphorus/total nitrogen to the apparatus for predicting the real-time water quality 100. Here, the multi-parameter water quality may be a water quality parameter that is able to be measured by the plurality of water quality sensors 110 in real time, and may include water temperature, electric conductivity, dissolved oxygen, hydrogen ion concentration, oxidation-reduction potential (ORP), turbidity, chlorophyll, nitrate nitrogen, and ammonium nitrogen.

The flow rate sensor 120 may estimate a flow rate at a location where the flow rate sensor 120 is installed, create flow rate information based on the estimated flow rate, and transmit the flow rate information to the apparatus for predicting the real-time water quality 100.

Here, the location at which the flow rate sensor 120 is installed may be identical to the location at which the plurality of water quality sensors 110 is installed. Also, when the location at which the plurality of water quality sensors 110 is installed is a location with little flow rate change, the flow rate sensor 120 may be installed in a predetermined distance apart from the plurality of water quality sensors 110. For example, when the plurality of water quality sensors 110 is installed in a lake with a relatively consistent flow rate, only a single flow rate sensor 120 may be installed. However, the flow rate sensor 120 may be installed at a location identical to a location at which the plurality of water quality sensors 110 is installed, and estimate a flow rate at a location where the plurality of water quality sensors 110 estimates the multi-parameter water quality when the plurality of water quality sensors 110 is installed in a stream with a flow rate differing from a flow rate at the location at which the plurality of water quality sensors is installed.

The apparatus for estimating the total phosphorus/total nitrogen 130 may estimate a total phosphorus or a total nitrogen at a location where the plurality of water quality sensors 110 is installed, using the multi-parameter water quality received from the plurality of water quality sensors 110. Also, the apparatus for estimating the total phosphorus/total nitrogen 130 may create the water quality information of the plurality of water quality sensors 110 including the estimated total phosphorus or total nitrogen and the multi-parameter water quality measured by the plurality of water quality sensors 110, and transmit the water quality information to the apparatus for estimating the real-time water quality 100.

Also, the apparatus for estimating the total phosphorus/total nitrogen 130 may be an apparatus for collecting data to collect the multi-parameter water quality measured by the plurality of water quality sensors 110. For example, the apparatus for estimating the total phosphorus/total nitrogen 130 may be installed in a server identical to a server in which the apparatus for predicting the real-time water quality 100 is installed. The apparatus for predicting the real-time water quality 100 may estimate a total phosphorus or a total nitrogen using the multi-parameter water quality received from the plurality of water quality sensors 110, and provide the estimated total phosphorus or total nitrogen to the apparatus for predicting the real-time water quality 100.

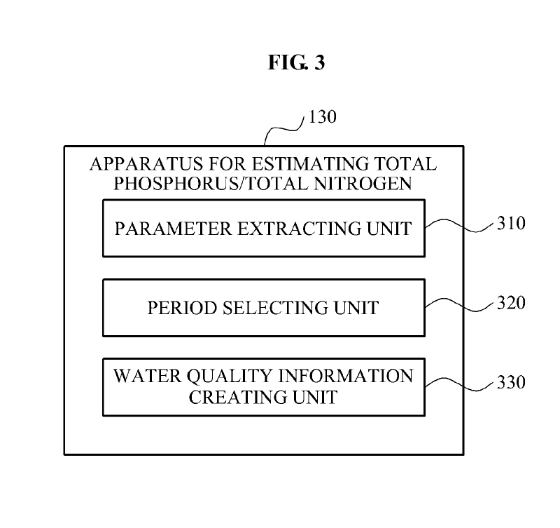

Hereinafter, a process in which the apparatus for estimating the total phosphorus/total nitrogen 130 estimates the total phosphorus or total nitrogen will be described with reference to FIG. 3.

Also, a complex sensor 130 may be used in lieu of the plurality of water quality sensors 110 and the flow rate sensor 120 according to the system for predicting the real-time water quality. Here, the complex sensor 130 may include functions of the plurality of water quality sensors 110 and the flow rate sensor 120. Further, the complex sensor 130 may be installed at a location where the plurality of water quality sensors 110 and the flow rate sensor 120 are to be installed adjacent to each other in a one-to-one arrangement, or installed along with the plurality of water quality sensors 110 on a lake.

Accordingly, the complex sensor 130 may measure the multi-parameter water quality and the flow rate of the location at which the complex sensor 130 is installed, estimate the total phosphorus or the total nitrogen of the location at which the complex sensor 130 is installed, based on the estimated multi-parameter water quality, and transmit, to the apparatus for predicting the real-time water quality 100, flow information created based on water quality information including the multi-parameter water quality and the estimated total phosphorus or total nitrogen and the estimated flow rate.

That is, the system for predicting the real-time water quality according to the present invention may increase an accuracy of the hydrodynamic model used for predicting the water quality, by measuring the flow rate of the location at which the plurality of water quality sensors 110 is installed, using the flow rate sensor 120.

FIG. 2 is a block diagram illustrating an apparatus for predicting a real-time water quality according to an embodiment of the present invention.

Referring to FIG. 2, the apparatus for predicting the real-time water quality 100 may include a hydrodynamic model creating unit 210, an information extracting unit 220, and an information selecting unit 230, and a water quality predicting unit 240.

The hydrodynamic model creating unit 210 may create a hydrodynamic model optimized to a location at which a water quality is to be predicted, based on flow rate information received from the flow rate sensor 120.

More particularly, the hydrodynamic model creating unit 210 may make a correction to optimize the hydrodynamic model to an environment in which the plurality of water quality sensors 110 and a plurality of flow rate sensors 120 is installed, based on a number of the flow rate sensors 120 and the flow rate information received from the plurality of flow rate sensors 120.

The information extracting unit 220 may extract basic parameter information for operating the hydrodynamic model by data mining a multi-parameter water quality received from the plurality of water quality sensors 110. Here, the basic parameter extracted from the information extracting unit 220 may be determined based on a type of hydrodynamic model.

The information selecting unit 230 may select a material that is able to be set to be a dissolved nonreactive material among water quality information received from the apparatus for estimating the total phosphorus/total nitrogen 130.

Here, the material selected by the information selecting unit 230 to be set as the dissolved nonreactive material may be at least one of a material having a relatively low rate of reaction when compared to a physical change among materials included in a total phosphorus or total nitrogen and the multi-parameter water quality estimated by the apparatus for estimating the total phosphorus/total nitrogen 130.

Also, the information selecting unit 230 may input an average value, a median value, or a real-time estimating value for each period with respect to the selected materials, in the water quality predicting unit 240 as a representative value of the hydrodynamic model.

For example, when the information selecting unit 230 selects the total phosphorus or the total nitrogen as the material that is able to be set to be the dissolved nonreactive material, the information selecting unit 230 may input a median value or an average value for each period of time series information with respect to the total phosphorus/total nitrogen estimated by the plurality of water quality sensors 110 and a predetermined total phosphorus/total nitrogen, in the water quality predicting unit 240 as the representative value of the hydrodynamic model.

The water quality predicting unit 240 may predict a water quality by applying the water quality information of the plurality of water quality sensors 110 received from the apparatus for estimating the total phosphorus/total nitrogen 130 to the hydrodynamic model created by the hydrodynamic model creating unit 210. Here, the hydrodynamic model used by the water quality predicting unit 240 may be a model that configures a grid based on a section in an aquatic environment in which the plurality of water quality sensors 110 and the flow sensor 120 are installed, and performs a simulation using information obtained via diverse paths with respect to various correlation functions and boundary conditions in the grid and information with respect to geographical, physical, and geological conditions of the aquatic environment.

More particularly, the water quality predicting unit 240 may predict the water quality by applying the basic parameter extracted by the information extracting unit 220 and the representative value that is input by the information selecting unit 230 to the hydrodynamic model created by the hydrodynamic creating unit 210.

Further, the water quality predicting unit 240 may set, in the hydrodynamic model created by the hydrodynamic model creating unit 210, the material selected by the information selecting unit 230 to be the dissolved nonreactive material, and predict the water quality by applying the basic parameter extracted by the information extracting unit 220 to the hydrodynamic model in which the selected material is set to be the dissolved nonreactive material. Here, the water predicting unit 240 may predict a current distribution status and a future change of the selected material. Here, the current distribution status of the material predicted by the water quality predicting unit 240 may be used as an absolute value representative of the aquatic environment.

For example, when the information selecting unit 230 selects the total phosphorus/total nitrogen, the water quality predicting unit 240 may predict a total phosphorus/total nitrogen distribution, using the hydrodynamic model. Here, the predicted total phosphorus/total nitrogen distribution may be used as an absolute value that represents a total phosphorus/total nitrogen distribution of a corresponding aquatic environment.

FIG. 3 is a block diagram illustrating a water quality sensor according to an embodiment of the present invention.

An apparatus for estimating a total phosphorus/total nitrogen 130 may include a parameter extracting unit 310, a period selecting unit 320, and a water quality information creating unit 330.

The parameter extracting unit 310 may extract a water quality parameter that increases or maintains a determination coefficient of a regression model among a multi-parameter water quality received from the plurality of water quality sensors 110, by conducting a variation analysis.

The period selecting unit 320 may select a period in which the determination coefficient of the regression model is greatest and the regression model is most accurate.

The water quality information creating unit 330 may estimate a total phosphorus or a total nitrogen at a location where the plurality of water quality sensors 110 is installed, by applying the extracted water quality parameter and the selected period to the regression model.

Also, the water quality information creating unit 330 may create water quality information of the plurality of water quality sensors 110 that includes the estimated total phosphorus or total nitrogen and the multi-parameter water quality measured by the plurality of water quality sensors 110, and transmit the water quality information to the apparatus for predicting the real-time water quality 100.

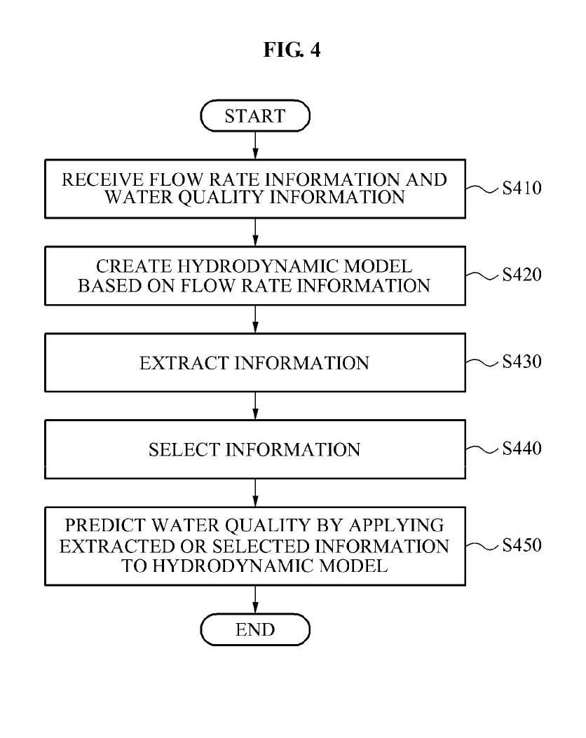

FIG. 4 is a flowchart illustrating a method for predicting a real-time water quality according to an embodiment of the present invention.

In operation S410, the apparatus for predicting the real-time water quality 100 may receive the water quality information of the plurality of water quality sensors 110 from the apparatus for estimating the total phosphorus/total nitrogen 130, and receive flow rate information of a location at which the plurality of water quality sensors 110 is installed from the flow rate sensor 120. Here, the apparatus for predicting the real-time water quality 100 may receive a multi-parameter water quality from the plurality of water quality sensors 110 when a total phosphorus or a total nitrogen is not used for a material that is able to be set to be a dissolved nonreactive material.

In operation S420, the hydrodynamic model creating unit 210 may create a hydrodynamic model optimized to a location at which a water quality is to be predicted, based on the flow information received in operation S410.

In operation S430, the information extracting unit 220 may extract basic parameter information for operating the hydrodynamic model by data mining the water quality information received in operation S410. Here, when the total phosphorus or total nitrogen is not used for the material that is able to be set to be the dissolved nonreactive material, the information extracting unit 220 may extract the basic parameter information for operating the hydrodynamic model by data mining the multi-parameter water quality received in operation S410.

In operation S440, the information selecting unit 230 may select the material that is able to be set to be the dissolved nonreactive material among the water quality information received in S410. Here, the information selecting unit 230 may input an average value, a median value, or a real-time estimated value for each period with respect to the selected material, in the water quality predicting unit 240 as a representative value of the hydrodynamic model.

Here, the material that is able to be set to be the dissolved nonreactive material may include at least one of the total phosphorus or total nitrogen estimated by the apparatus for estimating the total phosphorus/total nitrogen 130 and materials having a relatively low rate of reaction when compared to a physical change.

In operation S450, the water quality predicting unit 240 may predict the water quality by applying the water quality information received in operation S410 to the hydrodynamic model created in S420.

More particularly, the water quality predicting unit 240 may predict the water quality by applying the basic parameter extracted in operation S430 and the representative value that is input in operation S440 to the hydrodynamic model created in operation S420.

Also, the water quality predicting unit 240 may set, in the hydrodynamic model created in operation S420, the material selected in operation S440 to be the dissolved nonreactive material, and predict the water quality by applying the basic parameter extracted in operation S430 to the hydrodynamic model in which the material selected in operation S440 is set to be the dissolved nonreactive material.

According to embodiments of the present invention, it is possible to optimize a hydrodynamic model used for predicting a water quality to a location at which the plurality of water quality sensors 110 is installed, using a flow rate of the location at which the plurality of water sensors 110 is installed, and predict the water quality in real time by predicting the water quality using the optimized hydrodynamic model.

According to embodiments of the present invention, there is provided an apparatus and method for using an estimation value of a total phosphorus or total nitrogen as an absolute value representative of a total phosphorus or total nitrogen value in an aquatic environment, by setting the estimation value of the total phosphorus or total nitrogen to be a dissolved nonreactive material and applying the estimation value of the total phosphorus or total nitrogen to a hydrodynamic model.

According to embodiments of the present invention, it is possible to optimize a hydrodynamic model to a location at which a water quality sensor is installed, using a flow rate of the location at which the water quality sensor is installed, and predict a water quality in real time, using the optimized hydrodynamic model.

According to embodiments of the present invention, there is provided an apparatus and method for using an estimation value of a total phosphorus or total nitrogen as an absolute value representative of a total phosphorus or total nitrogen distribution in an aquatic environment, by setting the estimation value of the total phosphorus or total nitrogen to be a dissolved nonreactive material and applying the estimation value of the total phosphorus or the total nitrogen to the hydrodynamic model.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for predicting a real-time water quality, the apparatus comprising:
a hydrodynamic model creating unit to create a hydrodynamic model optimized to a location at which a water quality sensor is installed, based on flow rate information; and
a water quality predicting unit to predict a water quality by applying water quality information of the water quality sensor to the optimized hydrodynamic model.

2. The apparatus of claim 1, wherein the water quality predicting unit applies a total phosphorus or a total nitrogen among the water quality information to the hydrodynamic model, by setting the total phosphorus or the total nitrogen as a dissolved nonreactive material.

3. The apparatus of claim 1, wherein the water quality information comprises a multi-parameter water quality estimated by a water sensor and a total phosphorus or a total nitrogen estimated by an apparatus for estimating a total phosphorus/total nitrogen using the multi-parameter water quality.

4. The apparatus of claim 1, wherein the apparatus for estimating a total phosphorus/total nitrogen comprises:
a parameter extracting unit to extract a water quality parameter that increases or maintains a coefficient of determination of a regression model in a multi-parameter water quality received from a water quality sensor, by conducting a variation analysis;
a period selecting unit to select a period in which the coefficient of determination of the regression model is greatest and the regression model is most accurate, by conducting a time series analysis; and
a water quality information creating unit to estimate a total phosphorus or a total nitrogen at a location where the water quality sensor is installed, by applying the extracted parameter and the selected period to the regression model, and to create water quality information that comprises the estimated total phosphorus or total nitrogen and the multi-parameter water quality received from the water quality sensor.

5. The apparatus of claim 1, wherein the water quality predicting unit uses an average value, a median value, or a real-time measurement value for each period with respect to a total phosphorus or a total nitrogen, as a representative value of a hydrodynamic model.

6. The apparatus of claim 1, wherein the water quality predicting unit applies at least one of materials having a relatively low rate of reaction when compared to a physical change among water quality information, by setting the at least one of materials as a dissolved nonreactive material.

7. A method for predicting a water quality, the method comprising:
creating a hydrodynamic model optimized to a location at which a water quality is to be predicted based on flow rate information; and
predicting the water quality by applying water quality information of a water quality sensor to the optimized hydrodynamic model.

8. The method of claim 7, wherein the predicting of the water quality comprises:
applying a total phosphorus or a total nitrogen among water quality information to a hydrodynamic model, by setting the total phosphorus or the total nitrogen as a dissolved nonreactive material.

9. The method of claim 7, wherein the water quality information comprises a multi-parameter water quality estimated by a water sensor and a total phosphorus or a total nitrogen estimated by an apparatus for estimating a total phosphorus/total nitrogen using the multi-parameter water quality.

10. The method of claim 7, wherein the predicting of the water quality comprises using an average value, a median value, or a real-time measurement value for each period with respect to a total phosphorus or a total nitrogen, as a representative value of a hydrodynamic model.

11. The method of claim 7, wherein the predicting of the water quality comprises:
applying materials that have a relatively low rate of reaction when compared to a physical change among water quality information to a hydrodynamic model, by setting at least one of the materials as a dissolved nonreactive material.

12. The method of claim 11, wherein the predicting of the water quality comprises:
using an average value, a median value, or a real-time measurement value for each period with respect to materials that are set to be dissolved nonreactive materials as a representative value of a hydrodynamic model.
